(19) United States
(12) Patent Application Publication
(10) Pub. No.: US 2013/0081320 A1
(43) Pub. Date: Apr. 4, 2013

(54) FISHING LURE

(71) Applicant: Duncan John Robertson, Durban (ZA)

(72) Inventor: Duncan John Robertson, Durban (ZA)

(21) Appl. No.: 13/703,488

(22) PCT Filed: Mar. 2, 2012
(86) PCT No.: PCT/ZA12/00013

§ 371 Date: Dec. 11, 2012

(30) Foreign Application Priority Data
Mar. 2, 2011 (ZA) 2010/06488

(51) Int. Cl. A01K 85/00

(52) U.S. Cl. CPC A01K 85/00
USPC 43/42.49

(57) ABSTRACT

The invention provides a fishing lure comprising a body (10) having an appearance generally attractive to fish and one or more hooks (30, 32) supported on a fishing line. The hooks are disengagable from the body, which a recess (22) for receiving an insert (26) and the line in a friction fit. The insert and line are releasable from the recess upon the application of opposing longitudinal forces to the line.

### TECHNICAL FIELD OF THE INVENTION

The invention relates to a fishing lure.

### BACKGROUND ART

A fishing lure is an object attached to the end of a fishing line, designed to resemble and move like the prey of a fish. The purpose of the lure is to lure the fish into biting the hook. Lures are equipped with one or more hooks for hooking the fish when it attacks the lure.

Conventional lures have the hooks secured to the body of the lure. This can result in various problems, including the scenario where a hooked fish uses the weight and leverage of the lure to help dislodge the hook/s from its mouth. In addition, the lure can be subject to structural damage. Furthermore, the lures can snag on underwater objects such as rocks, resulting in them being lost or damaged.

It is an object of this invention to provide a fishing lure that, at least partially alleviates some of the abovementioned problems.

### DISCLOSURE OF THE INVENTION

In accordance with this invention there is provided a fishing lure comprising a body and one or more hooks supported on a fishing line, the hooks being disengageable from the body, the body having an appearance generally attractive to fish and further including one or more fishing line engagement means, characterised in that,
the body includes a recess for receiving an insert and the line in a friction fit,
the insert and line being releasable from the recess upon the application of opposing longitudinal forces to the line (hook).

The body of the lure includes a zone/s, which when the line is under tension from the opposing forces, acts to provide a transverse force on the line to overcome the frictional force retaining the insert releasing the lure to move along the line, away from the hook/s

The insert includes a passage, through which the fishing line, supporting one or more hooks, may be threaded.

The recess may be located on the base of the lure, and preferably towards the front of the lure.

A resiliently deformable o-ring may be located at the entrance of the recess for receiving the insert in a friction fit.

The insert is preferably a threadable bead or other spherical body.

The fishing line engagement means may include one or more eyelets located on the lure body, alternatively one or more threadable holes extending through the body of the lure.

The line engagement means preferably includes a hole or eyelet located towards the nose of the body.

The lure body may additionally include a slot, extending through the tail of the lure, for receiving the fishing line.

A first or tail hook is secured at the end of the line with a second or floating hook being free to move along the line.

The tail hook may be retained in abutment with the tail of the lure by maintaining the fishing line in the slot under tension.

The second, floating hook, may be retained in abutment with the base of the lure when the fishing line is under tension.

A slotted projection may extend from behind the recess, for receiving the fishing line and retaining the second hook in place when the line is under tension.

The lure may be constructed from buoyant material such as a plastics material, alternatively the lure may be constructed for a heavier material including lead or other metal.

The lure may include a spinner or spoon.

### BRIEF DESCRIPTION OF THE DRAWINGS

An embodiment of the invention is described below with reference to the accompanying drawings, in which:

FIG. 1 is a representation of the lure, fishing line and hooks, during rigging

FIG. 2 is a representation of the lure once rigged

FIG. 3 is a representation of the fishing lure when the hooks are under tension, following a fish strike for example.

FIG. 4 is a representation of the fishing lure once the insert has been ejected from the recess.

### DETAILED DESCRIPTION OF THE PREFERRED EMBODIMENT

The fishing lure comprises a body 10 having a likeness of a small fish. An eyelet 14 is located on the body 10 and a passage 16 passes through the nose of the body. A fishing line 20 is threaded through the eyelet 14 and hole or eyelet 16.

A recess 22 is located at the base of the body 10, and includes a rubber o-ring 24 at its entrance for receiving a threadable bead or spherical body 26 in a friction fit.

A slot 28, extends through the tail of the lure, for receiving the fishing line 20.

A tail hook 30, attached to the end of the fishing line 20 is retained in abutment with the tail of the lure when the fishing line 20 pulled taut in the direction of the arrows 40.

A second, floating hook 32, is retained in abutment with the base of the lure body 10 when the fishing line 20 is pulled taut in the direction of the arrows 40.

A hook stop in the form of a projection 34 extends from behind the recess 22, for retaining the second hook 32 in place when the line is pulled taut.

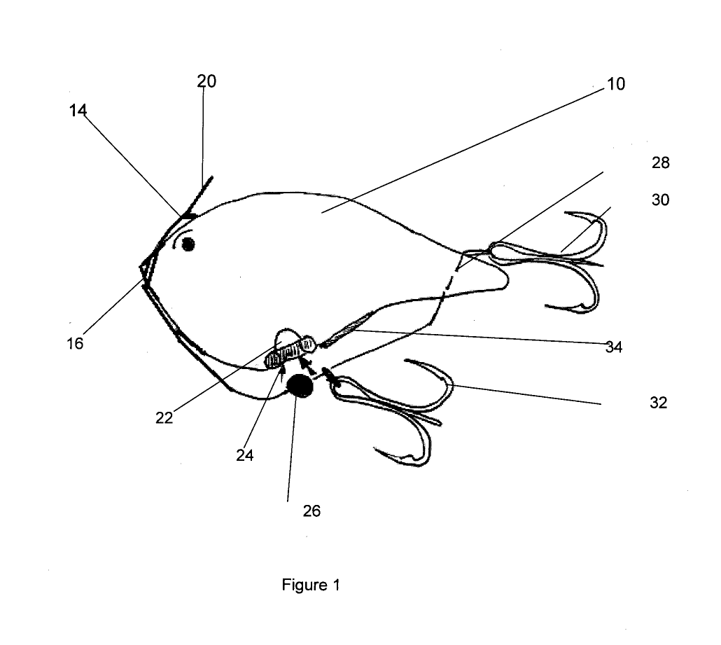

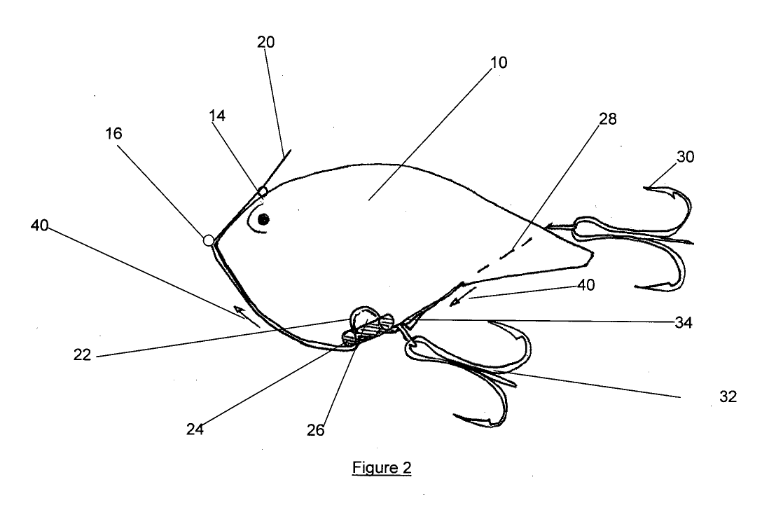

Referring to FIGS. 1 and 2, during rigging of the lure for fishing, the fishing line 20 is threaded through the eyelet 14 and hole or second eyelet 16. A spherical bead 26 is then threaded onto the line, after which a floating hook 32 is threaded onto the line 20. Finally a terminal tail hook 30 is tied to the end of the line 20.

The tail hook 30 is positioned at the end of the tail slot 28, with the line 20 passing through the tail slot 28. The line 20 is pulled taut at the nose hole or eyelet 16 creating tension on the line. The floating hook 32 is held in position by the stop 34. The bead 26 is pushed into the recess 22, past the o-ring 24, and retained in position by the friction fit created by the o-ring 24.

The line 20, passing through the bead 26 is compressed by the o-ring 24, thus maintaining tension in the line 20 between the bead and the tail hook 30, and holding the hooks in position on the body of the lure during casting or trolling of the lure.

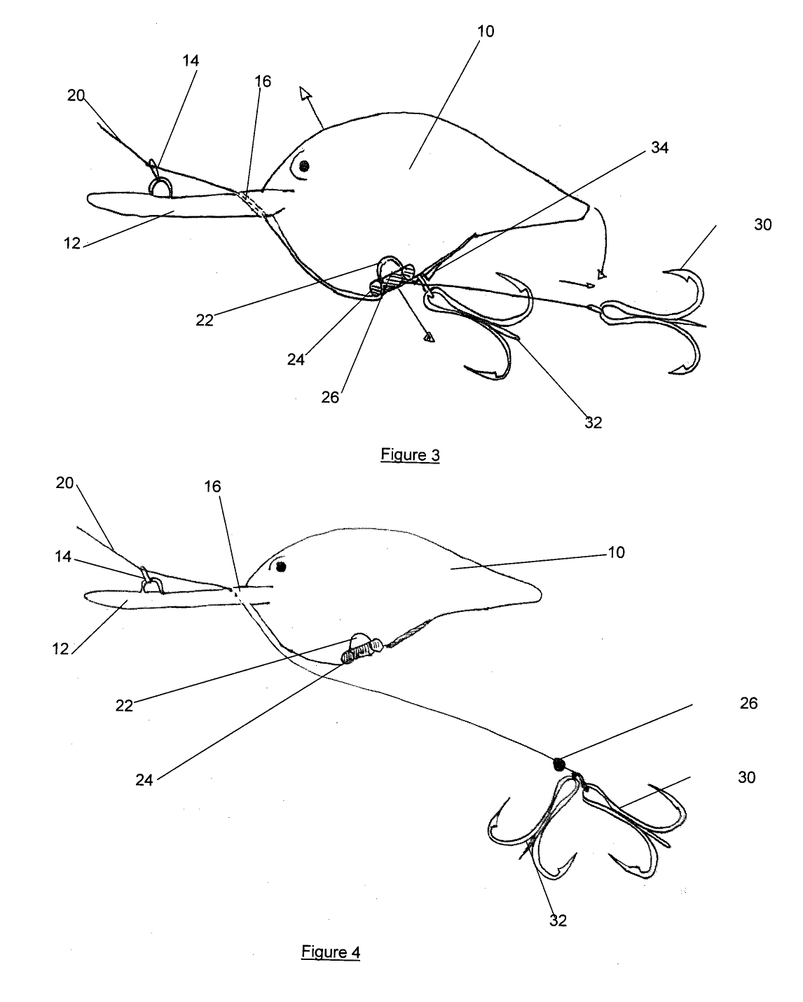

Referring to FIG. 3, resistance on the tail hook 30, caused through a fish strike or snagging of the hook on debris, will cause the line 20 to stretch slightly in the zone between the bead 26 and the tail hook 30. The stretching of the line 20, will allow the tail hook 30 to move out of the tail slot 28 and pull below the body of the lure.

Referring to FIG. 4, as the tension in the line increases further, the line's natural tendency is to define a straight line from the nose hole 16 to the hook 30. The body of the lure 10 acts as a cam or fulcrum and the line 20 passing through the bead 26 and compressed by the o-ring 24 is subject to tension, which transfers into an ejection force on the bead 26, forcing the bead 26 past the o-ring 24 and out of the recess 22.

It will be noted from FIGS. 3 and 4 that the shape of the lure body 10 is not limited, and may include extensions such as a diving nose 12.

This means that the lure body is free to move up the line towards the rod or in instances where the line snaps, to float back to the surface.

1. A fishing lure comprising a body and one or more hooks supported on a fishing line, the hooks being disengageable from the body, the body having an appearance generally attractive to fish and further including one or more fishing line engagement means, characterized in that the body includes a recess for receiving an insert and the line in a friction fit, the insert and line being releasable from the recess upon the application of opposing longitudinal forces to the line.

2. A fishing lure as claimed in claim 1, characterized in that the body of the lure includes azone/s, which when the line is under tension from the opposing forces, acts to provide a transverse force on the line to overcome the frictional force retaining the insert, releasing the lure to move along the line, away from the hook/s.

3. A fishing lure as claimed in claim 1, characterized in that the insert includes a passage, through which the fishing line, supporting one or more hooks, may be threaded.

4. A fishing lure as claimed in claim 1, characterized in that the insert is a threadable bead or other spherical body.

5. A fishing lure as claimed in claim 1, characterized in that the recess is located on the base of the lure.

6. A fishing lure as claimed in claim 5, characterized in that the recess is positioned towards the front of the base of the lure.

7. A fishing lure as claimed in claim 1, characterized in that a resiliently deformable o-ring is located at the entrance of the recess for receiving the insert in a friction fit.

8. A fishing lure as claimed in claim 1, characterized in that the fishing line engagement means include one or more eyelets located on the lure body.

9. A fishing lure as claimed in claim 1, characterized in that the fishing line engagement means include one or more threadable holes extending through the body of the lure.

10. A fishing lure as claimed in claim 1, characterized in that the fishing line engagement means includes at least one hole or eyelet located towards the nose of the body.

11. A fishing lure as claimed in claim 1, characterized in that a first or tail hook is secured at the end of the line with a second or floating hook being free to move along the line.

12. A fishing lure as claimed in claim 1, characterized in that the lure body includes a slot extending through the tail of the lure for receiving the fishing line.

13. A fishing lure as claimed in claim 11, characterized in that the tail hook is retained in abutment with the tail of the lure by maintaining the fishing line in the slot under tension.

14. A fishing lure as claimed in claim 11, characterized in that the second, floating hook, is retained in abutment with the base of the lure when the fishing line is under tension.

15. A fishing lure as claimed in claim 14 characterized in that a slotted projection extends from behind the recess, for receiving the fishing line and retaining the second hook in place when the line is under tension.

16. A fishing lure as claimed in claim 1. characterized in that the lure is constructed from buoyant material such as a plastics material.
